(19) United States
(12) Patent Application Publication
(10) Pub. No.: US 2018/0268385 A1
(43) Pub. Date: Sep. 20, 2018

(54) METHOD AND SYSTEM FOR INTEGRATION OF ELECTRONIC TRANSACTION SERVICES

(71) Applicant: Mastercard International Incorporated, Purchase, NY (US)

(72) Inventor: Saravana Perumal SHANMUGAM, Fremont, CA (US)

(73) Assignee: Mastercard International Incorporated, Purchase, NY (US)

(21) Appl. No.: 15/463,023

(22) Filed: Mar. 20, 2017

(51) Int. Cl. G06Q 20/10; G06F 17/30; G06F 17/27

(52) U.S. Cl. CPC G06Q 20/10; G06F 17/2765; G06F 17/30684

(57) ABSTRACT

A method for integration of merchant transaction services includes: storing a plurality of merchant profiles, each including a keyword, merchant data, communication data, and requested data fields; receiving a data message from a computing device; identifying a specific keyword based on the data message; identify merchant profiles that include the specific keyword; identifying data values corresponding to the requested fields included in the identified merchant profiles; transmitting a confirmation request to the computing device including the merchant data included in each identified merchant profile; receiving a confirmation notification from the computing device indicating one of the identified merchant profiles; and transmitting a transaction notification to a merchant related to the indicated merchant profile using the communication data included therein, wherein the transaction notification includes the identified data values.

### FIELD

The present disclosure relates to the integration of merchant transaction services, specifically the use of a digital conversation platform to enable the integration of transaction services for a plurality of different merchants across a plurality of different service types without the use of separate application programs and payment platforms.

### BACKGROUND

When out and about, an individual may have a desire or need to avail themselves of various services that are offered by merchants. For instance, an individual may need a car service, may desire food to be delivered, may want to send flowers or a gift to a friend, may need to book a hotel room for an evening, etc. In many cases, the individual would have to contact each merchant individually to avail themselves of their services. For convenience, many merchants are associated with application programs executable by a computing device (e.g., such as via a smart phone) where the individual may purchase their services. However, in instances where the individual has a need to purchase several services, this may require the individual to locate, install, execute, register with, and utilize a different application program for each service, which may be very time consuming and inconvenient.

Furthermore, if an individual is traveling to an unfamiliar area, the individual may be entirely unfamiliar with merchants that may offer the needed services. For instance, an individual that goes to a new city on business may be unfamiliar with car services that they may hire, local hotels where they may stay, and local restaurants that may deliver to their hotel. In such instances, the individual would first have to identify suitable merchants for each of these requested services, identify their associated application programs, install the programs, and then purchase the services. Such a time consuming process may dissuade the individual from future travels or from visiting unfamiliar locations.

Thus, there is a need for a technical solution whereby merchant transaction services may be integrated into a single application program, such that the individual may purchase services from merchants without the need to identify the merchants ahead of time or use extra application programs.

### SUMMARY

The present disclosure provides a description of systems and methods for integration of merchant transaction services. The use of a single application program that can enable an individual to avail themselves of services from a plurality of different merchants may provide the individual with significant convenience and efficiency in purchasing services. In addition, the ability for the single application program to identify merchants for selection by the individual may enable the individual to secure requested services without having to identify merchants, which may further increase the convenience for the individual, particularly when traveling to new locations where they may be unfamiliar with local merchants.

A method for integration of merchant transaction services includes: storing, in a merchant database of a processing server, a plurality of merchant profiles, wherein each merchant profile includes data related to a merchant including at least a keyword, merchant data, communication data, and one or more requested data fields; receiving, by a receiving device of the processing server, a data message from a computing device; identifying, by a data identification module of the processing server, a specific keyword based on the received data message; executing, by a querying module of the processing server, a query on the merchant database to identify at least one merchant profile where the included keyword corresponds to the specific keyword; identifying, by the processing server, data values corresponding to each of the one or more requested fields included in each of the identified at least one merchant profiles; electronically transmitting, by a transmitting device of the processing server; a confirmation request to the computing device, wherein the confirmation request includes at least the merchant data included in each of the at least one merchant profiles; receiving, by the receiving device of the processing server, a confirmation notification from the computing device, wherein the confirmation notification indicates one of the identified at least one merchant profiles; and electronically transmitting, by the transmitting device of the processing server, a transaction notification to the merchant related to the indicated merchant profile using the communication data included in the indicated merchant profile, wherein the transaction notification includes at least the identified data values.

A system for integration of merchant transaction services includes: a transmitting device of a processing server; a merchant database of the processing server configured to store a plurality of merchant profiles, wherein each merchant profile includes data related to a merchant including at least a keyword, merchant data, communication data, and one or more requested data fields; a receiving device of the processing server configured to receive a data message from a computing device; a data identification module of the processing server configured to identify a specific keyword based on the received data message; and a querying module of the processing server configured to execute a query on the merchant database to identify at least one merchant profile where the included keyword corresponds to the specific keyword, wherein the processing server is configured to data values corresponding to each of the one or more requested fields included in each of the identified at least one merchant profiles, the transmitting device of the processing server is further configured to electronically transmit a confirmation request to the computing device, wherein the confirmation request includes at least the merchant data included in each of the at least one merchant profiles, the receiving device of the processing server is further configured to receive a confirmation notification from the computing device, wherein the confirmation notification indicates one of the identified at least one merchant profiles, and the transmitting device of the processing server is further configured to electronically transmit a transaction notification to the merchant related to the indicated merchant profile using the communication data included in the indicated merchant profile, wherein the transaction notification includes at least the identified data values.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for the integration of merchant transaction services in accordance with exemplary embodiments.

FIG. 2 is a block diagram illustrating the processing server of the system of FIG. 1 for the integration and facilitation of merchant transaction services in accordance with exemplary embodiments.

FIGS. 3A and 3B are a flow diagram illustrating a process for the purchase of merchant services via transaction service integration using the system of FIG. 1 in accordance with exemplary embodiments.

FIG. 4 is a diagram illustrating a graphical user interface of the computing device of FIG. 1 for the purchase of merchant transaction services in accordance with exemplary embodiments.

FIG. 5 is a flow chart illustrating an exemplary method for the integration of merchant transaction services in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

### System for Integration of Merchant Transaction Services

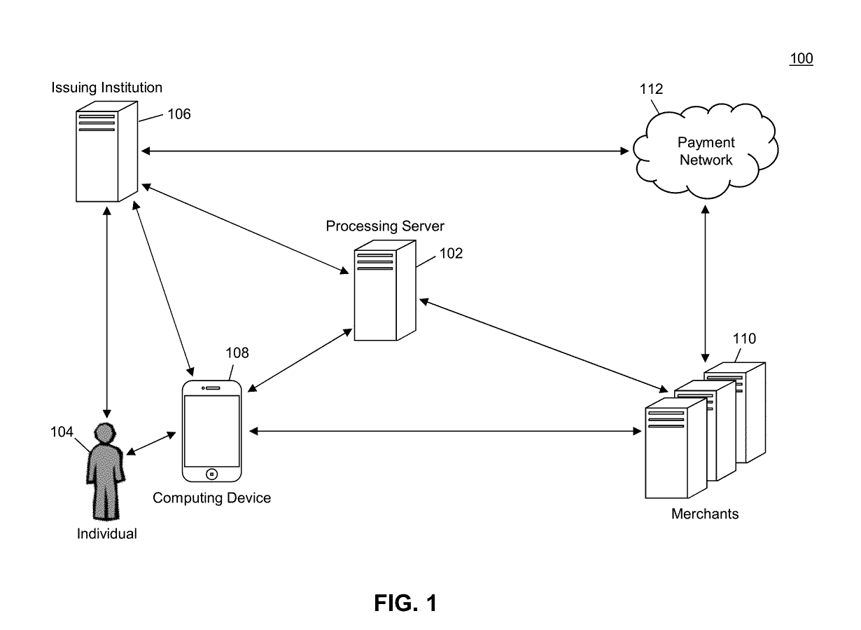

FIG. 1 illustrates a system 100 for the integration of merchant transaction services for the purchase of services provided by a plurality of different merchants for a plurality of different services via the use of a single application program executed by a user computing device.

The system 100 may include a processing server 102. The processing server 102, discussed in more detail below, may be configured to facilitate the purchase of merchant services via the integration of merchant transaction services into a single platform provided to an individual 104. The processing server 102 may be configured such that the individual 104 may utilize a single application program to purchase merchant services across a plurality of different merchants and merchant services via integration of transaction services into the single application program, without the need for the individual 104 to identify merchants directly or communicate therewith, or utilize separate application programs for securing each merchant service.

The system 100 may also include an issuing institution 106. The issuing institution 106 may be a financial institution, such as an issuing bank, or other entity that is configured to issue transaction accounts to individuals 104 for use in funding electronic payment transactions. The issuing institution 106 may issue a transaction account to the individual 104 for use thereby in the funding of electronic payment transactions entered into by the individual 104, such as electronic payment transactions facilitated through the services provided by the processing server 102. As part of the issuing of the transaction account, the issuing institution 106 may issue payment credentials to the individual 104 associated with the transaction account that may be presented during the transaction process.

The individual 104 may possess or otherwise have access to a computing device 108 for use in performing the functions discussed herein. The computing device 108 may be any type of computing device specifically configured to perform the functions discussed herein, such as a specially configured desktop computer, laptop computer, notebook computer, tablet computer, cellular phone, smart phone, smart watch, smart television, wearable computing device, implantable computing device, etc. In some embodiments, the issuing institution 106 may be configured to provision payment credentials directly to the computing device 108, which may be configured to store or otherwise access the payment credentials for use in electronic payment transactions conducted therewith.

The individual 104 may be configured to use the computing device 108 to access services provided by the processing server 102. The computing device 108 may be configured to execute an application program for communication with the processing server 102, which may facilitate the exchange of data signals between the computing device 108 and processing server 102 that are superimposed or otherwise encoded with data for performing the functions discussed herein. The computing device 108 and processing server 102 may communicate using any suitable type of communication network and method, such as via a cellular communication network, local area network, Bluetooth, radio frequency, the Internet, etc. In one embodiment, the application program may be directly associated with the processing server 102, such as an application program developed by the processing server 102 or on behalf thereof, that is used solely for accessing the services of the processing server 102. In other embodiments, the application program may be a communication program used to facilitate communication between the individual 104 and other entities, which may include the processing server 102.

In one instance, the application program may be a digital conversation application program, which may facilitate the exchange of digital conversation messages between the individual 104 and another entity, such as the processing server 102 or a representative (e.g., a live person, artificial intelligence, specialized program, etc.) thereof. In such instances, the individual 104 may write natural language messages that may be conveyed to the processing server 102 via the computing device 108 for processing thereof. In these instances, the processing server 102 may be configured to generate natural language messages as responses for providing notifications and other information as discussed herein to the individual 104 via the computing device 108 using the digital conversation application program. In some cases, the application program may be configured to provide additional functions beyond digital conversation, which may be one feature of the application program. For instance, the application program may be associated with a social network, for which the digital conversation is one feature.

Using the platform associated with the processing server 102, the individual 104 may, using the computing device 108, request merchant services from the processing server 102. The individual 104 may submit a data message to the processing server 102 (e.g., as a natural language message) that includes a keyword associated with a merchant service being requested. In instances where the data message is a natural language message, the processing server 102 may use traditional methods for the processing thereof to identify a keyword from the natural language. The processing server 102 may then, using the keyword, identify a plurality of merchants 110 associated with the requested service that may be available for providing the service to the individual 104. For example, the keyword may be “taxi,” where the merchants 110 may be car services, or the keyword may be “food,” where the merchants 110 may be restaurants offering delivery, or the keyword may be “hotel,” where the merchants 110 may be hotels.

In some instances, the data message may include additional criteria used in the identification of the merchants 110. For instance, the data message may include a geographic location, such as supplied by the individual 104 or by the computing device 108 (e.g., identified thereby), to identify car services or hotels in the area. In another example, the data message may include a cuisine type requested for eligible merchants 110. Other criteria may include, for instance, car type, number of passengers, travel distance, room type, hotel classification, delivery range, etc. In cases where a digital conversation application program may be used, such criteria may be incorporated into the natural language message. For example, the individual 104 may transmit to the processing server 102, “I need a car service to pick me up from the airport, and I want a luxury sedan not a taxi.” In such an example, the processing server 102 may identify merchants 110 that can pick up from the airport and that operate car services that utilize luxury sedans and not taxis.

The processing server 102 may identify merchants 110 that are eligible for providing the requested service to the individual 104. The processing server 102 may then determine what other information may be needed from the individual 104 for the merchant 110 in order to provide the service, and may request the individual 104 (e.g., via the computing device 108) to provide the additional information. For instance, in the above example, the processing server 102 may request the individual 104 to provide their destination. In instances where a digital conversation application program may be used, the request for additional data may be submitted using natural language, such as the processing server 102 asking the individual, “Where is your intended destination?” The individual 104 may then provide data values for the additional information to the processing server 102, using the computing device 108. For instance, in the above example, the individual 104 may respond with “The Patent and Trademark Office in Alexandria.”

The processing server 102 may receive the additional data values, and, if applicable, may filter the identified merchants 110 based thereon. For instance, in the above example, the destination may be out of the service area for one of the car services. The processing server 102 may then present each of the identified merchants 110 to the individual 104 (e.g., via the computing device 108) for selection. In some embodiments, the processing server 102 may first estimate the expense associated with the service for each of the identified merchants 110. In some cases, the merchants 110 may provide pricing information to the processing server 102 ahead of time, for use by the processing server 102 in calculating price estimates. In other cases, the processing server 102 may request a price estimate, or actual amount to be charged if the service is purchased, from each identified merchant 110 using the data values provided by the individual 104. In such embodiments, the price estimates or costs may be presented to the individual 104 with the identified merchants 110 for selection. The individual 104 may then select one of the merchants 110 and notify the processing server 102 accordingly using the computing device 108.

In some embodiments, the processing server 102 may be configured to identify a merchant 110 for the individual 104. For instance, the processing server 102 may identify the eligible merchants 110 and their estimated prices, and may be configured to select a merchant 110 based thereon. In some cases, the individual 104 may provide criteria for the selection of the merchant 110 by the processing server 102. For example, the individual 104 may provide such criteria in the initial request or a later message submitted to the processing server 102, such as, “I want the cheapest car service,” or, “I want whichever car service can get me there the fastest.” In such an example, the processing server 102 may select a merchant 110 based thereon, such as by selection a merchant 110 with the lowest price estimate or the fastest reported response times. In such embodiments, the processing server 102 may select the merchant 110 and provide information associated with the merchant 110 (e.g., name and any information associated with the criteria, such as the cost or response time) to the individual 104 for confirmation.

Once the individual 104 has selected or otherwise confirmed a merchant 110, the processing server 102 may notify the merchant 110 of the individual 104 and the data values for the service being requested. For instance, in the above example, the processing server 102 may notify the selected car service of the individual's location and destination. The merchant 110 may then dispatch a car to the individual 104 to pick them up at the airport and take them to the Patent and Trademark Office. As a result, the individual 104 may be able to secure the purchase of a car service to take them to their destination in a new area where they are unfamiliar with the car services located there or their service areas, without the need to identify eligible merchants or locate means for purchasing the services of the merchants.

In some embodiments, the processing server 102 may be configured to facilitate payment for services being purchase from selected merchants 110. In a first embodiment, the processing server 102 may electronically transmit a notification to the computing device 108 that may include merchant information associated with the selected merchant 110 for payment thereto, such as a merchant identification number, transaction account number, or other number suitable for use in directing payment to the selected merchant 110, or for establishing communication with the merchant 110. For instance, the processing server 102 may provide a merchant identification number and transaction amount for the purchase of the service to the computing device 108, where the computing device 108 may use an electronic wallet application program (e.g., as part of the same application program used to communicate with the processing server 102, or in communication therewith) to initiate the transfer of the transaction amount from the individual's transaction account to the identified merchant 110.

In a second embodiment, the individual 104 may provide payment credentials to the processing server 102 for use in payment for the requested service from the identified merchant 110. In such an embodiment, the individual 104 may provide the payment credentials issued thereto by the issuing institution 106, such as in the original data message or subsequent to a request therefor by the processing server 102. In some cases, the individual 104 may provide the payment credentials directly (e.g., written in a natural language message submitted to the processing server 102 using the application program), or by instructing a third party application program (e.g., an electronic wallet application program) for transmission thereto. The processing server 102 may receive the payment credentials, which may be provided to the identified merchant 110 along with the other data values for the requested service. The merchant 110 may then initiate a payment transaction for the purchase of the service, supplying the received payment credentials such that the issued transaction account is used to fund the transaction.

In a third embodiment, the processing server 102 may store payment credentials on behalf of individuals 104. For instance, the individual 104 may supply the processing server 102 with the payment credentials prior to the purchasing of services. In some cases, the issuing institution 106 may provision payment credentials directly to the processing server 102. The processing server 102 may store the payment credentials therein. When the individual 104 requests services from a merchant 110, the individual 104 may provide the processing server 102 with identification and authentication information to identify previously provided payment credentials and to authenticate the individual's access thereto. Following successful identification and authentication, the processing server 102 may electronically transmit the payment credentials to the identified merchant 110 along with the data values for the requested service.

In some embodiments, the processing server 102 may utilize payment tokens for the storage and provisioning of payment credentials. For example, the issuing institution 106 may provision a payment token to the processing server 102 that is associated with a transaction account. The payment token may be presented to a merchant 110 in place of traditional payment credentials that, when processed using traditional transaction processing methods, may be mapped to the associated transaction account. In some cases, the processing server 102 may be configured to perform the mapping between payment tokens and corresponding payment credentials. In such cases, the processing server 102 may receive a payment token from the computing device 108 for a transaction account to be used in funding the purchase of services, may identify the corresponding payment credentials, and supply the payment credentials to the identified merchant 110.

The merchant 110 may receive the payment credentials and data values for the requested service. The merchant 110 may then initiate an electronic payment transaction for payment of the services, with the payment credentials being supplied for funding of the payment transaction by the corresponding transaction account. The payment credentials, and other transaction data for the transaction account (e.g., the transaction amount, transaction time, transaction date, geographic location, currency type, merchant data, product data, reward data, offer data, loyalty data, etc.) may be submitted to a payment network 112 for processing thereby. In some instances, the transaction data may be submitted to the payment network 112 directly by the merchant 110. In other instances, the transaction data may be submitted to the payment network 112 via one or more intermediate entities, such as an acquiring institution or gateway processor. In some cases, the transaction data may be included in a transaction message specially formatted pursuant to one or more standards governing the exchange of financial transaction messages, such as the International Organization of Standardization's ISO 8583 or 20022 standards. The payment network 112 may then process the payment transaction using traditional methods and systems, which may include contacting the issuing institution 106 for authorization of the payment transaction for funding by the selected transaction account.

The methods and systems discussed herein may enable an individual 104 to secure merchant services from a plurality of different merchants 110 across a plurality of different services, without requiring the individual 104 to identify any merchants 110 for a particular service or to contact merchants 110 directly, and thus freeing the individual 104 from having to utilize multiple application programs and/or communication channels to purchase merchant services. The processing server 102 can thus provide individuals 104 with significantly greater convenience and efficiency in securing merchant services, particular when individuals 104 are traveling to unfamiliar areas and may not be familiar with local service providers.

### Processing Server

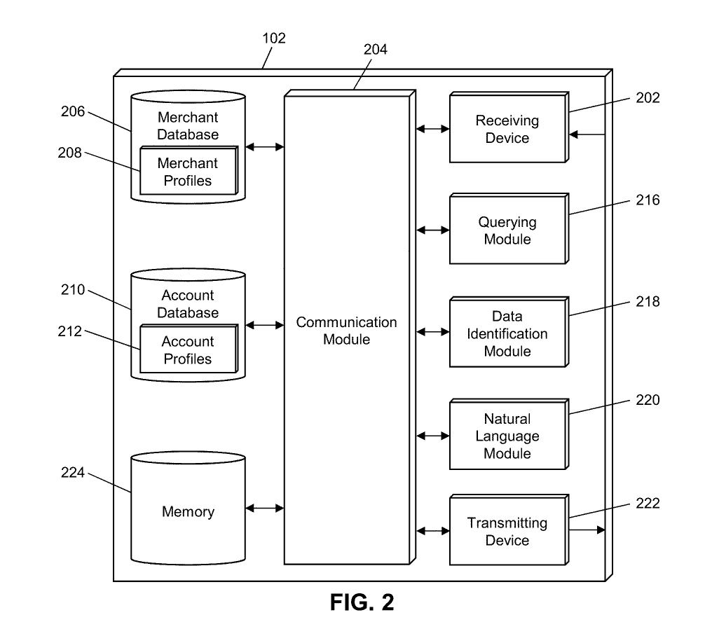

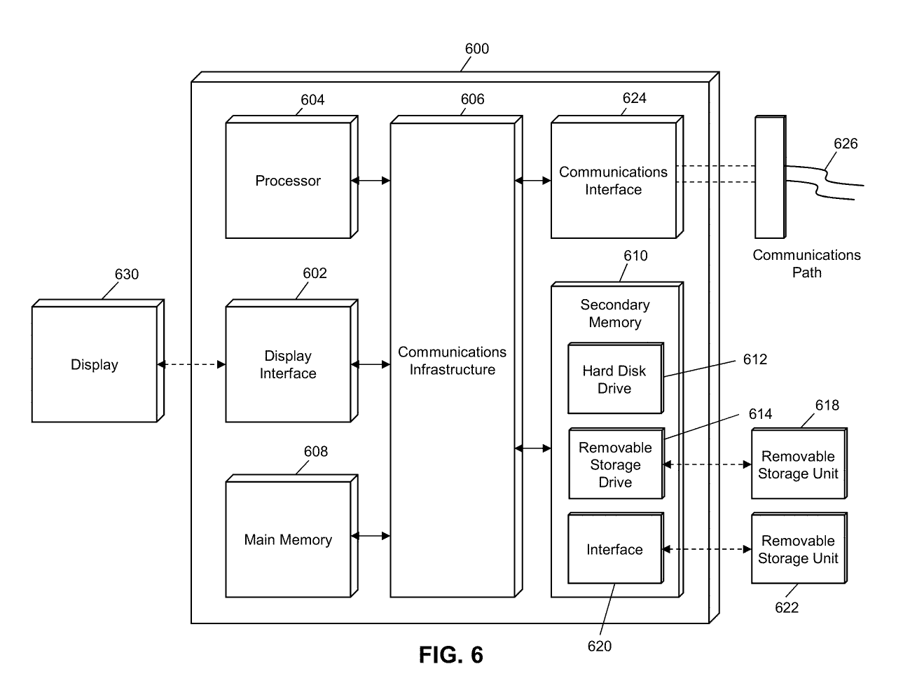

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 600 illustrated in FIG. 6 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from issuing institutions 106, computing devices 108, merchants 110, and other systems and entities via one or more communication methods, such as near field communication, local area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by issuing institutions 106 that are superimposed or otherwise encoded with payment tokens or payment credentials for storage thereby. The receiving device 202 may also be configured to receive data signals electronically transmitted by computing devices 108, which may be superimposed or otherwise encoded with data messages, which may be written in natural language for processing by the processing server 102. The data messages may include data suitable for performing the functions discussed herein, such as service keywords, data values, payment credentials, payment tokens, selection criteria, etc. In some instances, the receiving device 202 may also be configured to receive data signals electronically transmitted by merchants 110, such as may be superimposed or otherwise encoded with price estimates, pricing information, or other data suitable for use in identifying eligible merchants 110 and selecting merchants 110 for services.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 216, data identification module 218, natural language module 220, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may include a merchant database 206. The merchant database 206 may be configured to store a plurality of merchant profiles 208 using a suitable data storage format and schema. The merchant database 206 may be a relational database that utilizes structured query language for the storage, identification, modifying, updating, accessing, etc. of structured data sets stored therein. Each merchant profile 208 may be a structured data set configured to store data related to a merchant 110 with whom services may be purchased. A merchant profile 208 may include at least a keyword, merchant data, communication data, and one or more requested data fields. The keyword may be one or more keywords associated with services provided by the related merchant 110, for use in identification of the merchant 110 as an eligible merchant for providing a service requested by the individual 104. The merchant data may include data associated with the related merchant 110 that may be used in the identification or selection thereof by the processing server 102 and/or individual 104, such as merchant name, pricing information, merchant category, or other attributes, which may be dependent on the type of merchant (e.g., room types for a hotel, vehicle types for a car service, cuisine type for a restaurant, etc.). Communication data may be data used for establishing communication with the related merchant 110, by the processing server 102 or for providing to a computing device 108 for communication with the related merchant 110, such as for initiating payment thereto. The one or more requested data fields may be data fields for which the related merchant 110 requests data in order to provide the requested service to the individual 104, such as a pickup location and destination for a car service, food order for a restaurant, check in and check out dates for a hotel, etc.

In some embodiments, the processing server 102 may also include an account database 210. The account database 210 may be configured to store a plurality of account profiles 212 using a suitable data storage format and schema. The account database 210 may be a relational database that utilizes structured query language for the storage, identification, modifying, updating, accessing, etc. of structured data sets stored therein. Each account profile 212 may be a structured data set configured to store data related to a transaction account used to fund electronic payment transactions. An account profile 212 may include at least an account identifier and payment credentials. The account identifier may be an identification value suitable for use in identifying the account profile 212, such as a username, e-mail address, password, telephone number, device identifier, identification number, etc. In some instances, the account identifier may be a part of the payment credentials, such as a transaction account number. The payment credentials may include data necessary for inclusion in a transaction message submitted to a payment network 112 for use in funding of an electronic payment transaction by the related transaction account, such as a transaction account number, name, expiration date, security code, etc. In some embodiments, an account profile 212 may also be configured to store a payment token, for use in mapping thereof to corresponding payment credentials. In some cases, an account profile 212 may also include authentication data, which may be used to authenticate an individual 104 to ensure usage of the related transaction account by only authorized users.

The processing server 102 may include a querying module 216. The querying module 216 may be configured to execute queries on databases to identify information. The querying module 216 may receive one or more data values or query strings, and may execute a query string based thereon on an indicated database, such as the memory, to identify information stored therein. The querying module 216 may then output the identified information to an appropriate engine or module of the processing server 102 as necessary. The querying module 216 may, for example, execute a query on the merchant database 206 to identify merchant profiles 208 that include a keyword supplied by an individual 104 for requesting a related service. The querying module 216 may also, for example, execute queries on the account database 210 to identify account profiles 212 indicated by individuals 104 for the supplying of payment credentials included therein for the purchasing of merchant services.

The processing server 102 may also include a data identification module 218. The data identification module 218 may be configured to identify data for use in performing the functions of the processing server 102 as discussed herein. The data identification module 218 may receive an instruction as input, may identify data based on the instruction, and may output the identified data to another module or engine of the processing server 102. For example, the data identification module 218 may be configured to identify keywords in data messages received (e.g., via the receiving device 202) from computing devices 108, to identify price estimates or other data associated with identified merchant profiles 208 based on supplied information (e.g., data values, merchant data, etc.), to identify a specific merchant profile 208 for confirmation by an individual 104 based on criteria supplied thereby, etc. In some instances, the data identification module 218 may be configured to identify if an individual 104 is an authorized user of a transaction account based on authentication data stored in a related account profile 212 and data supplied by the individual 104 (e.g., via the computing device 108).

In some embodiments, the processing server 102 may include a natural language module 220. The natural language module 220 may be configured to parse natural language messages and generate natural language messages for use by the processing server 102 in performing the functions discussed herein. The natural language module 220 may be configured to generate natural language messages, whereby the natural language module 220 may receive data to be included in the natural language message and may, using one or more algorithms associated therewith, generate the natural language message that includes the supplied data. The natural language module 220 may also be configured to identify data values in a natural language message supplied thereto, and output the data values to another module or engine of the processing server 102, such as by processing the natural language message using suitable algorithms known to persons having skill in the relevant art. For example, the natural language module 220 may be configured to identify keywords, data values, payment credentials, payment tokens, authentication data, selection criteria, etc. in natural language messages received in a digital conversation, or to generate a natural language response that includes merchant data and confirmation data. Methods for parsing and generating natural language messages will be apparent to persons having skill in the relevant art.

The processing server 102 may also include a transmitting device 222. The transmitting device 222 may be configured to transmit data over one or more networks via one or more network protocols. In some instances, the transmitting device 222 may be configured to transmit data to computing devices 108, merchants 110, and other entities via one or more communication methods, such as near field communication, cellular communication networks, local area networks, Bluetooth, radio frequency, the Internet, etc. In some embodiments, the transmitting device 222 may be comprised of multiple devices, such as different transmitting devices for transmitting data over different networks, such as a first transmitting device for transmitting data over a local area network and a second transmitting device for transmitting data via the Internet. The transmitting device 222 may electronically transmit data signals that have data superimposed that may be parsed by a receiving computing device. In some instances, the transmitting device 222 may include one or more modules for superimposing, encoding, or otherwise formatting data into data signals suitable for transmission.

The transmitting device 222 may be configured to electronically transmit data signals to computing devices 108, which may be superimposed or otherwise encoded with data messages, such as may include merchant data, communication data, transaction notifications, etc. In some cases, the data messages may be formatted (e.g., by the natural language module 220) as natural language messages, which may convey data from the processing server 102 to the individual 104 using natural language. The transmitting device 222 may also be configured to electronically transmit data signals to merchants 110, which may be superimposed or otherwise encoded with transaction notifications, wherein a transaction notification may include at least data values identified for a requested service as supplied by the individual 104, and may also include payment credentials related to a transaction account used to fund a transaction purchasing the requested service, as applicable.

The processing server 102 may also include a memory 224. The memory 224 may be configured to store data for use by the processing server 102 in performing the functions discussed herein, such as public and private keys, symmetric keys, etc. The memory 224 may be configured to store data using suitable data formatting methods and schema and may be any suitable type of memory, such as read-only memory, random access memory, etc. The memory 224 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 224 may be comprised of or may otherwise include a relational database that utilizes structured query language for the storage, identification, modifying, updating, accessing, etc. of structured data sets stored therein.

### Process for Facilitation of Merchant Transaction Services

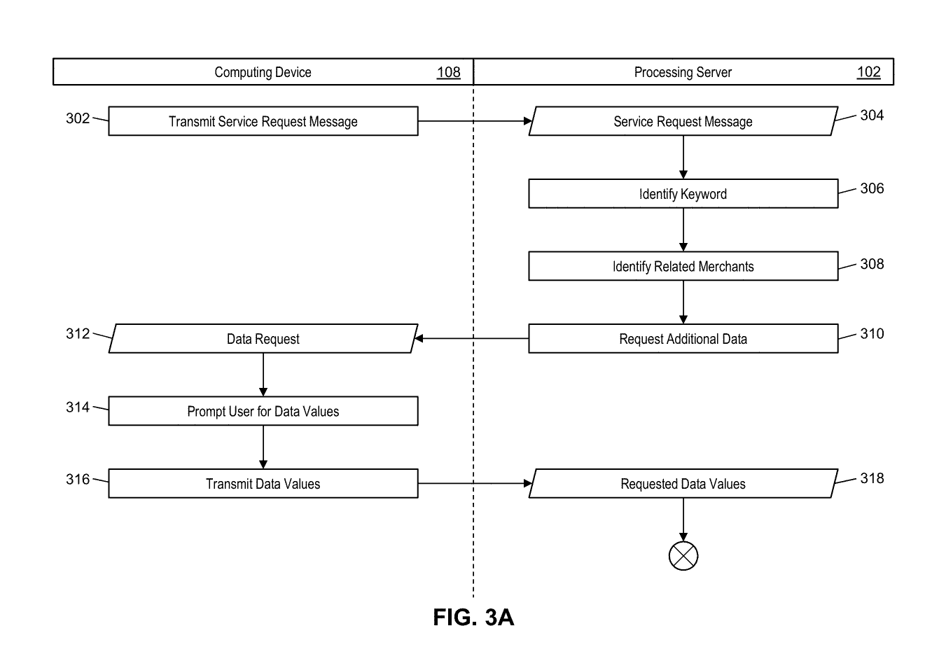

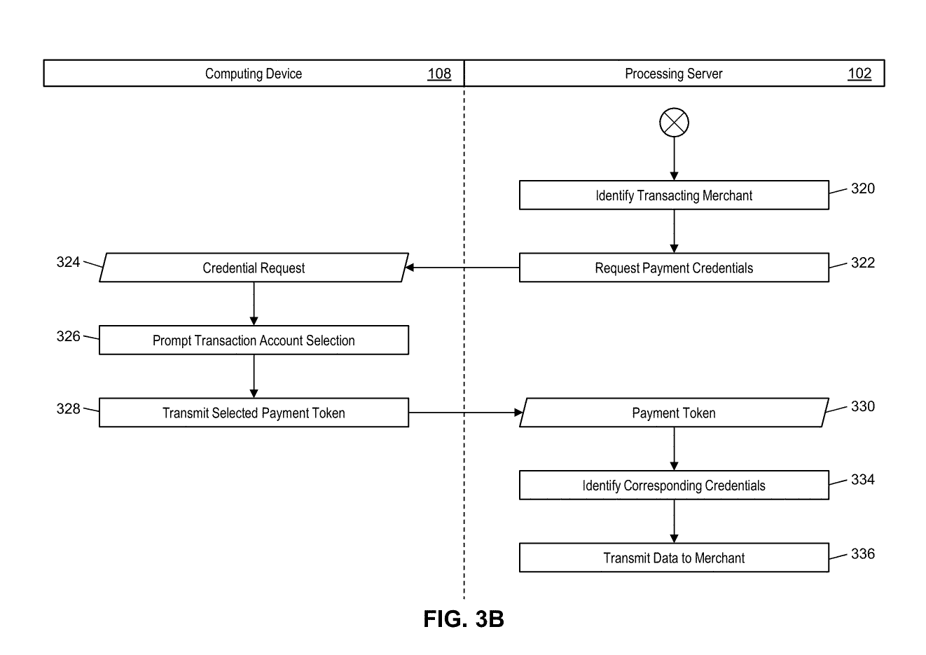

FIGS. 3A and 3B illustrate a process for the facilitation of merchant transaction services by the processing server 102 in the system 100, for the securing of merchant services on behalf of the individual 104.

In step 302, the computing device 108 may electronically transmit a service request data message to the processing server 102 using a suitable communication network and method, such as via a cellular communication network and/or the Internet. The service request data message may be, in some embodiments, a natural language message that requests a service to be provided to the individual 104 as a user of the computing device 108. In step 304, the receiving device 202 of the processing server 102 may receive the service request data message from the computing device 108. In step 306, the data identification module 218 of the processing server 102 may identify a keyword in the service request data message that is related to the service being requested. In embodiments where the service request data message is a natural language message, the data identification module 218 may instruct the natural language module 220 of the processing server 102 to process the natural language message for identification of the keyword therefrom.

In step 308, the querying module 216 of the processing server 102 may execute a query on the merchant database 206 of the processing server 102 to identify a plurality of merchant profiles 208 that include the keyword parsed from the service request data message, such that the identified merchant profiles 208 are related to merchants 110 that offer the requested service. In step 310, the transmitting device 222 of the processing server 102 may electronically transmit a request for additional data to the computing device 108. In instances where natural language may be used (e.g., where the communication with the computing device 108 is performed via a digital conversation application program), the natural language module 220 may be configured to generate a natural language message that comprises the request for additional data. The request for additional data may request data based on the requested data fields included in the identified merchant profiles 208.

In step 312, the computing device 108 may receive the request for additional data. In step 314, the computing device 108 may prompt the individual 104 to provide data values that correspond to the requested data fields, such as by displaying a prompt to the individual 104 via an interfaced display device and receiving input from the individual 104 via interfaced input devices. In step 316, the computing device 108 may electronically transmit the data values as supplied by the individual 104 to the processing server 102, which may be included in a natural language message, as applicable. In step 318, the receiving device 202 of the processing server 102 may receive the data values.

In step 320, the data identification module 218 of the processing server 102 may identify a transacting merchant 110 that will provide the requested service to the individual 104. In some embodiments, the transacting merchant 110 may be identified based on the additional data values supplied by the individual 104 and selection criteria, which may be have been provided with the additional data values or in the service request data message. In some cases, the data identification module 218 may select among the eligible merchants 110 using any other suitable criteria, such as random or pseudo-random selection, bidding, etc. In step 322, the transmitting device 222 of the processing server 102 may transmit a request for payment credentials to the computing device 108, to request credentials for payment to the transacting merchant 110.

In step 324, the computing device 108 may receive the request for payment credentials. In step 326, the computing device 108 may prompt the individual 104 to select a transaction account with which the individual 104 would like to pay for the service. In some instances, the computing device 108 may include an electronic wallet application program configured to store and access payment tokens for a plurality of transaction accounts, where the application program used to communicate with the processing server 102 may be configured to communicate with the electronic wallet application program for the selection and retrieval of payment tokens. In step 328, a payment token corresponding to the selected transaction account (e.g., retrieved via the electronic wallet application program) may be electronically transmitted from the computing device 108 to the processing server 102.

In step 330, the receiving device 202 of the processing server 102 may receive the payment token. In step 334, the querying module 216 of the processing server 102 may execute a query on the account database 210 to identify an account profile 212 that is related to the corresponding transaction account based on the payment token, and identify the payment credentials stored therein. In step 336, the transmitting device 222 of the processing server 102 may electronically transmit the payment credentials and the supplied data values to the transacting merchant 110 for use in initiating a payment transaction for purchase of the service and the providing of the service to the individual 104.

### Graphical User Interface

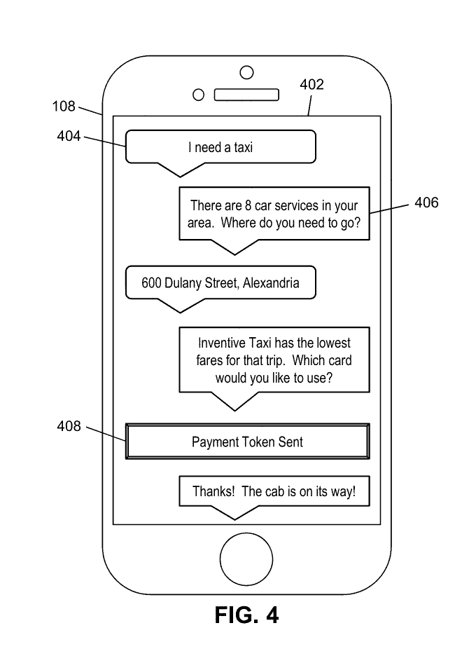

FIG. 4 illustrates an example graphical user interface of the computing device 108 for displaying a digital conversation between the individual 104 and the processing server for the securing of a merchant service. It will be apparent to persons having skill in the relevant art that the interface of the computing device 108 illustrated in FIG. 4 is provided as an illustration only, and that other graphical interfaces may be suitable for performing the functions discussed herein.

The computing device 108 may include a display device 402. The display device 402 may be configured to display a digital conversation between the individual 104 as a user of the computing device 108 and the processing server 102, such as may be displayed via a digital conversation application program executed by a processor of the computing device 108. The digital conversation may include one or more messages 404 from the individual 104 and one or more messages submitted by (e.g., via the transmitting device 222) the processing server 102.

As illustrated in FIG. 4, the digital conversation may include messages regarding the purchase of a merchant service. As illustrated, the individual 104 writes a natural language message to the processing server 102 requesting a taxi. The processing server 102 identifies the keyword requesting a taxi service and identifies that there are eight eligible merchants 110 operating in the area where the individual 104 is located (e.g., such as identified based on a geographic location of the computing device 108 transmitted to the processing server 102). The processing server 102 also requests additional data from the individual 104, specifically the individual's destination. The individual 104 provides the destination as an additional data value to the processing server 102. The processing server 102 estimates the fares for a trip from the individual's location to their stated destination for each of the eight eligible merchants 110, and identifies Inventive Taxi as having the lowest fares, and thus being the transacting merchant.

The processing server 102 also requests the individual 104 to provide payment information for paying for the taxi service. The individual 104 selects a payment token stored in the computing device 108 and supplies it to the processing server 102. The processing server 102 receives the payment token, and sends a notification to the computing device 108 for display to the individual 104 that the taxi has been ordered (e.g., via the transmission of a notification of the service request and the payment token and/or credentials to Inventive Taxi) and is on its way to the individual 104. As a result, the individual 104 has requested a service without having to be familiar with any merchants 110 and without having to utilize additional application programs for the facilitation thereof.

While FIG. 4 illustrates the use of short messaging service messaging, multimedia messaging service messaging, or other similar types of digital conversation interfaces, additional types of interfaces may be used in order to facilitate a digital conversation between the individual 104 and the processing server 102 for performing the functions discussed herein. For instance, the individual 104 may provide voice commands via the computing device 108, which may be responded to with text or vocal messages (e.g., computerized reading of text messages provided by the processing server 102). In another example, the individual 104 may communicate with a live user of the processing server 102 (e.g., via telephone, a digital conversation interface, etc.), who may relay the data provided by the processing server 102 back to the individual 104.

### Exemplary Method for Integration of Merchant Transaction Services

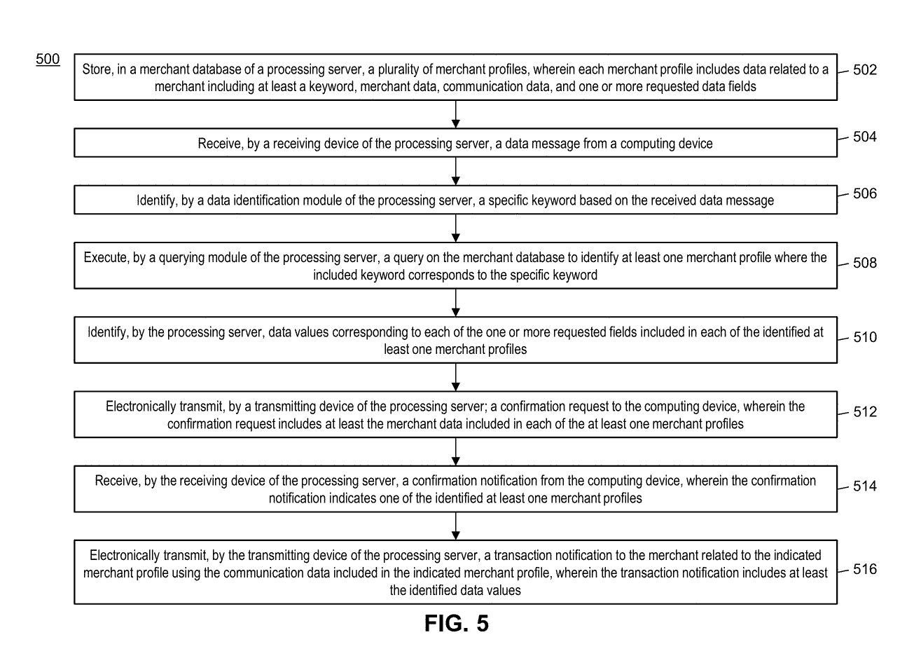

FIG. 5 illustrates a method 500 for the integration of merchant transaction services for a plurality of merchants across a plurality of different merchant services via a processing server specifically configured therefor.

In step 502, a plurality of merchant profiles (e.g., merchant profiles 208) may be stored in a merchant database (e.g., the merchant database 206) of a processing server (e.g., the processing server 102), wherein each merchant profile includes data related to a merchant (e.g., merchant 110) including at least a keyword, merchant data, communication data, and one or more requested data fields. In step 504, a data message may be received by a receiving device (e.g., the receiving device 202) of the processing server from a computing device (e.g., the computing device 108).

In step 506, a specific keyword may be identified by a data identification module (e.g., the data identification module 218) of the processing server based on the received data message. In step 508, a query may be executed by a querying module (e.g., the querying module 216) of the processing server on the merchant database to identify at least one merchant profile where the included keyword corresponds to the specific keyword. In step 510, data values corresponding to each of the one or more requested fields included in each of the identified at least one merchant profiles may be identified by the processing server.

In step 512, a confirmation request may be electronically transmitted by a transmitting device (e.g., the transmitting device 222) of the processing server to the computing device, wherein the confirmation request includes at least the merchant data included in each of the at least one merchant profiles. In step 514, a confirmation notification may be received from the computing device by the receiving device of the processing server, wherein the confirmation notification indicates one of the identified at least one merchant profiles. In step 516, a transaction notification may be electronically transmitted to the merchant related to the indicated merchant profile by the transmitting device of the processing server using the communication data included in the indicated merchant profile, wherein the transaction notification includes at least the identified data values.

In one embodiment, the data message may be written in a natural language, and the data identification module may be configured to process the natural language to identify the specific keyword. In some embodiments, the data values may be identified based on the received data message. In a further embodiment, the data message may be written in a natural language, and the data identification module may be configured to process the natural language to identify the data values.

In one embodiment, identifying the data values comprises: electronically transmitting, by the transmitting device of the processing server, a data request to the computing device, wherein the data request includes the one or more requested fields included in each of the identified at least one merchant profiles; and receiving, by the receiving device of the processing server, a data response from the computing device, wherein the data response includes the data values. In some embodiments, the method 500 may further include electronically transmitting, by the transmitting device of the processing server, the communication data included in the indicated merchant profile to the computing device for conveyance of payment credentials to the related merchant. In one embodiment, the data message may be received from the computing device via a digital conversation application program.

In some embodiments, the method 500 may also include storing, in an account database (e.g., the account database 210) of the processing server, an account profile (e.g., account profile 212), wherein the account profile includes data related to a transaction account including at least payment credentials and an account identifier, wherein the transaction notification further includes the payment credentials included in the account profile. In a further embodiment, the data message may further include the account identifier. In another further embodiment, the method 500 may even further include electronically transmitting, by the transmitting device of the processing server, an identifier request to the computing device, and receiving, by the receiving device, the account identifier from the computing device.

### Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3A, 3B, and 5.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device specifically configured to perform the functions discussed herein. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3A, 3B, and 5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

The processor device 604 may comprise one or more modules or engines configured to perform the functions of the computer system 600. Each of the modules or engines may be implemented using hardware and, in some instances, may also utilize software, such as corresponding to program code and/or programs stored in the main memory 608 or secondary memory 610. In such instances, program code may be compiled by the processor device 604 (e.g., by a compiling module or engine) prior to execution by the hardware of the computer system 600. For example, the program code may be source code written in a programming language that is translated into a lower level language, such as assembly language or machine code, for execution by the processor device 604 and/or any additional hardware components of the computer system 600. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, systems and methods for integration of merchant transaction services. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for integration of merchant transaction services, comprising:
storing, in a merchant database of a processing server, a plurality of merchant profiles, wherein each merchant profile includes data related to a merchant including at least a keyword, merchant data, communication data, and one or more requested data fields;
receiving, by a receiving device of the processing server, a data message from a computing device;
identifying, by a data identification module of the processing server, a specific keyword based on the received data message;
executing, by a querying module of the processing server, a query on the merchant database to identify at least one merchant profile where the included keyword corresponds to the specific keyword;
identifying, by the processing server, data values corresponding to each of the one or more requested fields included in each of the identified at least one merchant profiles;
electronically transmitting, by a transmitting device of the processing server; a confirmation request to the computing device, wherein the confirmation request includes at least the merchant data included in each of the at least one merchant profiles;
receiving, by the receiving device of the processing server, a confirmation notification from the computing device, wherein the confirmation notification indicates one of the identified at least one merchant profiles; and
electronically transmitting, by the transmitting device of the processing server, a transaction notification to the merchant related to the indicated merchant profile using the communication data included in the indicated merchant profile, wherein the transaction notification includes at least the identified data values.

2. The method of claim 1, wherein
the data message is written in a natural language, and
the data identification module is configured to process the natural language to identify the specific keyword.

3. The method of claim 1, wherein the data values are identified based on the received data message.

4. The method of claim 2, wherein
the data message is written in a natural language, and
the data identification module is configured to process the natural language to identify the data values.

5. The method of claim 1, wherein identifying the data values comprises:
electronically transmitting, by the transmitting device of the processing server, a data request to the computing device, wherein the data request includes the one or more requested fields included in each of the identified at least one merchant profiles; and
receiving, by the receiving device of the processing server, a data response from the computing device, wherein the data response includes the data values.

6. The method of claim 1, further comprising:
electronically transmitting, by the transmitting device of the processing server, the communication data included in the indicated merchant profile to the computing device for conveyance of payment credentials to the related merchant.

7. The method of claim 1, further comprising:
storing, in an account database of the processing server, an account profile, wherein the account profile includes data related to a transaction account including at least payment credentials and an account identifier, wherein
the transaction notification further includes the payment credentials included in the account profile.

8. The method of claim 7, wherein the data message further includes the account identifier.

9. The method of claim 7, further comprising:
electronically transmitting, by the transmitting device of the processing server, an identifier request to the computing device, and
receiving, by the receiving device, the account identifier from the computing device.

10. The method of claim 1, wherein the data message is received from the computing device via a digital conversation application program.

11. A system for integration of merchant transaction services, comprising:
a transmitting device of a processing server;
a merchant database of the processing server configured to store a plurality of merchant profiles, wherein each merchant profile includes data related to a merchant including at least a keyword, merchant data, communication data, and one or more requested data fields;
a receiving device of the processing server configured to receive a data message from a computing device;
a data identification module of the processing server configured to identify a specific keyword based on the received data message; and
a querying module of the processing server configured to execute a query on the merchant database to identify at least one merchant profile where the included keyword corresponds to the specific keyword, wherein
the processing server is configured to data values corresponding to each of the one or more requested fields included in each of the identified at least one merchant profiles,
the transmitting device of the processing server is further configured to electronically transmit a confirmation request to the computing device, wherein the confirmation request includes at least the merchant data included in each of the at least one merchant profiles,
the receiving device of the processing server is further configured to receive a confirmation notification from the computing device, wherein the confirmation notification indicates one of the identified at least one merchant profiles, and
the transmitting device of the processing server is further configured to electronically transmit a transaction notification to the merchant related to the indicated merchant profile using the communication data included in the indicated merchant profile, wherein the transaction notification includes at least the identified data values.

12. The system of claim 11, wherein
the data message is written in a natural language, and
the data identification module is configured to process the natural language to identify the specific keyword.

13. The system of claim 11, wherein the data values are identified based on the received data message.

14. The system of claim 12, wherein
the data message is written in a natural language, and
the data identification module is configured to process the natural language to identify the data values.

15. The system of claim 11, wherein identifying the data values comprises:
electronically transmitting, by the transmitting device of the processing server, a data request to the computing device, wherein the data request includes the one or more requested fields included in each of the identified at least one merchant profiles; and
receiving, by the receiving device of the processing server, a data response from the computing device, wherein the data response includes the data values.

16. The system of claim 11, wherein the transmitting device of the processing server is further configured to electronically transmit the communication data included in the indicated merchant profile to the computing device for conveyance of payment credentials to the related merchant.

17. The system of claim 11, further comprising:
an account database of the processing server configured to store an account profile, wherein the account profile includes data related to a transaction account including at least payment credentials and an account identifier, wherein
the transaction notification further includes the payment credentials included in the account profile.

18. The system of claim 17, wherein the data message further includes the account identifier.

19. The system of claim 17, wherein
the transmitting device of the processing server is further configured to electronically transmit an identifier request to the computing device, and
the receiving device is further configured to receive the account identifier from the computing device.

20. The system of claim 11, wherein the data message is received from the computing device via a digital conversation application program.
